(19) United States
(12) Patent Application Publication
(10) Pub. No.: US 2017/0295415 A1
(43) Pub. Date: Oct. 12, 2017

(54) Agricultural Production Monitoring

(71) Applicant: Mist Labs, Inc., Sunnyvale, CA (US)

(72) Inventors: Ugur Oezdemir, Sunnyvale, CA (US); Matthew Kresse, Sunnyvale, CA (US); Scott Steber, San Francisco, CA (US); Agustus Shelander, San Mateo, CA (US)

(21) Appl. No.: 15/484,667

(22) Filed: Apr. 11, 2017

Related U.S. Application Data
(60) Provisional application No. 62/320,978, filed on Apr. 11, 2016.

(51) Int. Cl. H04Q 9/00; A01G 25/16; H04L 29/08

(52) U.S. Cl. CPC H04Q 9/00; H04L 67/12; A01G 25/16; A01G 25/167; H04Q 2209/40; H04Q 2209/886

(57) ABSTRACT

A system includes a data acquisition device that includes one or more sensors. The data acquisition device collects sensor data from the one or more sensors that measure one or more of the following: irrigation flow rate, irrigation water quality, intensity of solar radiation, ambient temperature, and ambient humidity. The system further includes a user interface module that collects condition data from a user. The system further includes a collection and analysis application that receives the sensor data from the data acquisition device, receives the condition data from the user interface module, analyzes the sensor data and the condition data, and generates analyzed data from the sensor data and the condition data. The user interface module generates a user interface that includes the analyzed data from the collection and analysis application.

### CROSS-REFERENCES TO RELATED APPLICATION

This application claims benefit to provisional patent application number 62/320,978, entitled “Agricultural Production Monitoring,” filed Apr. 11, 2016, which is incorporated by reference herein.

### FIELD

The embodiments discussed herein are related to an agricultural production environment. More particularly, the embodiments discussed herein relate to agricultural production monitoring.

### BACKGROUND

Managers of agricultural production environments may deploy sensors in their fields to monitor crop health as well as production equipment, with the purpose of identifying ways to increase crop productivity and resource efficiency.

### SUMMARY

A system of one or more computers can be operable to perform particular operations or actions by virtue of having software, firmware, hardware, or a combination of them installed on the system that in operation causes or cause the system to perform the actions. One or more computer programs can be operable to perform particular operations or actions by virtue of including instructions that, when executed by data processing apparatus, cause the apparatus to perform the actions.

One general aspect includes an agricultural production monitoring system, including: a data acquisition device, where the data acquisition device collects data from one or more sensors that measure one or more of the following: irrigation flow rate, irrigation water quality, intensity of solar radiation, ambient temperature, and ambient humidity. The agricultural production monitoring system also includes a cloud-based data collection and analysis application communicatively coupled to the data acquisition device and operable to analyze said data to generate analyzed data. The agricultural production monitoring system also includes a user interface module operable to collect user input data and display raw and analyzed data from the data collection and analysis application. Other embodiments of this aspect include corresponding computer systems, apparatus, and computer programs recorded on one or more computer storage devices, each operable to perform the actions of the methods.

Implementations may include one or more of the following features. The system may include a data acquisition device that is communicatively coupled to the cloud-based data collection and analysis application via a cellular communication mechanism. The system may include a data acquisition device that is communicatively coupled to the cloud-based data collection and analysis application via a separate internet-connected gateway device that is communicatively coupled to via a wireless network. The system may include an internet-connected gateway device that connects to the interne via using one or more of the following: a wireless communication mechanism, a wired communication mechanism, and a cellular communication mechanism. The system may include an internet-connected gateway device that is powered by a renewable power source operable to harvest energy and charge the gateway power supply using the harvested energy. The system may include an internet-connected gateway device that transmits additional data to the cloud-based data collection and analysis application from one or more on-board sensors that measure one or more of the following: intensity of solar radiation, ambient temperature, ambient humidity, and location of the data acquisition device. The system may include a cloud-based data collection and analysis application that uses data from both the data acquisition device and the internet-connected gateway device to perform one or more of the following analyses: plant canopy growth tracking, extreme temperature detection, high wind detection, plant damage detection, and device theft detection. The system may include a data acquisition device that is powered by a renewable power source operable to harvest energy and charge its power supply using the harvested energy. The system may include a cloud-based data collection and analysis application that performs one or more of the following analyses: irrigation system efficiency, irrigation system distribution uniformity, total field water usage estimation, water quality assessment, plant canopy growth tracking, irrigation system leakage detection, irrigation system blockage detection, irrigation system maintenance detection, extreme temperature detection, high wind detection, plant damage detection, and device theft detection. The system may include a cloud-based data collection and analysis application that combines sensor data from the data acquisition device with external cloud-based data sources in order to produce regulated deficit irrigation schedules, or more generally, to schedules that irrigate to a certain percentage of localized plant water demand (ETc). The system may include a user interface that is accessible by the user via an internet-connected client device. The system may include a user interface that sends alerts to the user based on analyzed data produced by the cloud-based data collection and analysis application which is determined to be of relevance to the user. Implementations of the described techniques may include hardware, a method or process, or computer software on a computer-accessible medium.

One general aspect includes a method for agricultural production monitoring, including collecting data on an agricultural production environment using a data acquisition device, where the data acquisition device collects data from one or more sensors that measure one or more of the following: irrigation flow rate, irrigation water quality, intensity of solar radiation, ambient temperature, and ambient humidity. The method also includes analyzing said data with a cloud-based data collection and analysis application that is communicatively coupled to the data acquisition device to generate analyzed data. The method also includes collecting user input data and displaying raw and analyzed data from a data collection and analysis application using a user interface module. Other embodiments of this aspect include corresponding computer systems, apparatus, and computer programs recorded on one or more computer storage devices, each operable to perform the actions of the methods.

Implementations may include one or more of the following features. The method may include analyzed data that includes one or more of the following: irrigation system efficiency, irrigation system distribution uniformity, total field water usage estimation, water quality assessment, plant canopy growth tracking, irrigation system maintenance detection, irrigation system leakage detection, irrigation system blockage detection, extreme temperature detection, high wind detection, plant damage detection, and device theft detection. The method may include a cloud-based data collection and analysis application that produces regulated deficit irrigation schedules, or more generally, to schedules that irrigate to a certain percentage of localized plant water demand (ETc), using a combination of sensor data from the data acquisition device along with external cloud-based data sources. The method may include a user interface module that sends alerts to the user based on analyzed data produced by the cloud-based data collection and analysis application that is determined to be of relevance to the user. The method may include a cloud-based data collection and analysis application that uses additional intensity of solar radiation, ambient temperature, and ambient humidity data from an internet-connected gateway device to perform one or more of the following analyses: plant canopy growth tracking, extreme temperature detection, high wind detection, plant damage detection, and device theft detection. Implementations of the described techniques may include hardware, a method or process, or computer software on a computer-accessible medium.

### BRIEF DESCRIPTION OF THE DRAWINGS

Example embodiments will be described and explained with additional specificity and detail through the use of the accompanying drawings in which:

FIG. 1 illustrates a block diagram of agricultural production monitoring system according to some embodiments;

FIG. 2 illustrates a diagram of the data acquisition device according to some embodiments; and

FIG. 3 illustrates a diagram of the gateway device according to some embodiments.

FIG. 4A illustrates a side view of a flow sensor according to some embodiments.

FIG. 4B illustrates a plan view of the flow sensor according to some embodiments.

FIG. 4C illustrates a bottom view of the flow sensor according to some embodiments.

FIG. 4D illustrates a rear view of the flow sensor according to some embodiments.

FIG. 5 illustrates an exploded view of the flow sensor according to some embodiments.

FIGS. 6A-6D illustrate four views of another embodiment of the flow sensor with orthographic dimensions.

FIGS. 7A-7C illustrate section views of another embodiment of the flow sensor.

FIG. 8 illustrates an exploded view of another embodiment of the flow sensor according to some embodiments.

FIG. 9 illustrates a block diagram of the collection and analysis application according to some embodiments.

FIG. 10 illustrates an example graphical user interface of a map view generated by the collection and analysis application 103 according to some embodiments.

FIG. 11 illustrates an example graphical user interface of a graph view generated by the collection and analysis application according to some embodiments.

FIG. 12 illustrates an example graphical user interface of a summary view generated by the collection and analysis application according to some embodiments.

FIG. 13 illustrates an example graphical user interface of an event view for data acquisition devices in an agricultural production environment generated by the collection and analysis application according to some embodiments.

FIG. 14 illustrates a graphical user interface of an event view for events corresponding to a data acquisition device generated by the collection and analysis application according to some embodiments.

FIG. 15 illustrates an example flow diagram of a method for generating analyzed data about an agricultural production environment.

### DETAILED DESCRIPTION

The disclosure relates to agricultural production monitoring.

Managers of agricultural production environments may deploy sensors in their fields to monitor crop health as well as production equipment, with the purpose of identifying ways to increase crop productivity and resource efficiency.

Many agricultural production environments have shifted to micro-irrigation systems, using tubes to convey water more directly to a plant's roots, reducing required water inputs to produce a given yield. These micro-irrigation systems can similarly be used to improve the efficiency of agrochemical applications, such as fertilizers, pesticides, and fungicides.

Micro-irrigation systems, nevertheless, can cause undesirable outcomes if the irrigation system was poorly designed or not well maintained. Either of these can lead to over-watering or under-watering plants, which can result in severe crop loss. Frequent and accurate monitoring of micro-irrigation systems is therefore an important task; however, current diagnostic procedures to identify issues are typically time-consuming and involve costly manual operations.

Many agricultural production environments have field workers that manually turn on and off irrigation valves to irrigate their fields. Managers often put considerable effort into prescribing specific amounts of water and agrochemicals to be applied to fields, but there is often no way to monitor and confirm how precisely the managers' intended application instructions were followed by the field workers. Irrigation logs consisting of watering start times and durations are often required to be taken by field workers, but this is a manual process, fraught with inaccuracies (both intentional and unintentional), and often requires additional transcription from paper to software-based records.

Such discrepancies can occur with irrigation system maintenance as well, where a manager may periodically prescribe running chemical solutions through irrigation systems in order to clean the irrigation tubes and emitters. Such discrepancies can degrade crop outcomes and impair future management efforts.

Regulated Deficit Irrigation (herein “RDI”) is an irrigation strategy especially popular with wine growers, whereby irrigation is reduced in order to apply water stress at specific times and durations to a crop to limit excessive vegetative growth and improve fruit quality. RDI is also employed as a means to limit water use in times of drought, while minimizing negative impact on crop production. Achievement of successful RDI requires accurate plant “water stress” sensing as well as accurate irrigation application monitoring. The challenges of deploying accurate irrigation application monitoring systems in such settings is often the barrier for growers from gaining the benefits of implementing RDI with their crops. In addition to RDI, many growers try to irrigate to a set percentage of crop water demand (ETc) and this percentage can vary depending on the growth stage of the crop. Irrigating to a set percentage of crop water demand involves the same challenges as does implementing RDI.

Many agricultural production environments track the size of the plant canopy of their crops in order to assess plant growth during the growing season. Based on this assessment, managers will alter their scheduling of crop management functions, such as irrigation, fertilizing, and harvesting. Aerial photography and spectral imaging by satellites, planes, or unmanned aerial vehicles is commonly used to assess plant canopy growth; however, these methods suffer from reflection and poor resolution issues and are costly, especially if frequent assessments are desired. One specific challenge for aerial imaging is the inability to differentiate the vegetative growth of the desired plant from the cover crop (e.g. grass) that frequently grows in between crop rows.

Many agricultural production environments grow crops that can be damaged and destroyed by ambient temperatures that become too hot and more commonly, too cold. Many operations install expensive equipment to aid in frost protection, such as giant air circulating fans as well as purpose-built sprinkler systems which spray water to insulate plants from frost. Indeed, if a frost event goes undetected, it can ruin an entire crop and growing season. Although, many growers install frost monitoring solutions in their fields, they are costly to procure and require maintenance. These burdens increase as growers attempt to increase their number of surface temperature data-points.

Many agricultural production environments, especially almond orchards, experience significant crop yield losses due to high winds shaking branches and causing unripened crop to prematurely fall. Excessively high winds can cause entire plants (e.g. trees) to be uprooted. Both these occurrences can produce critical losses for growers, which makes tracking where high winds are most affecting their plants a means to implement targeted safeguards to prevent future yield losses. Tracking both plant shaking and plant damage events can be done by tracking patterns of solar radiation transmission through a plant's canopy over time.

Many agricultural production environments not only suffer from crop loss, but also loss of the devices that hope to mitigate these issues due to theft. Given the remote locations and large unattended expanses of many crop fields, precision agricultural equipment is often difficult to protect from burglars.

According to some embodiments, the agricultural production monitoring system may be deployed in an agricultural production environment which may consist of one or more agricultural crop fields. These crop fields may be organized into rows of individual plants with uniform distances between individual plants and uniform distances between rows of plants. An irrigation system may be used to water the individual plants in these crop fields. The irrigation system components may consist of a collection pipes or tubes that originate from a common water pump and water source and which run down the length of each row of plants. The irrigation system components may include one or more of the following: sprinkler heads; drip irrigation hoses or drip emitters; and other micro-irrigation components used for distributing water to plants in a field. The irrigation system components may be arranged into one or more irrigation zones, or irrigation blocks, such that a single irrigation valve can be opened to a water pump to transfer water down a multiplicity of plant rows at one time. The data acquisition device may be installed in line with an irrigation pipe or tube located along one or more rows of plants, such that the irrigation water flows through the component before it emitted to the plants. The data acquisition device may be installed at a location beneath a plant's canopy, such that the solar energy transferred through the plant's canopy can be collected.

The data acquisition device includes one or more sensors that measure one or more of the following: irrigation flow rate, irrigation water quality, intensity of solar radiation, ambient temperature, and ambient humidity. The data acquisition device may collect sensor data. The sensor data may describe the measurements of the one or more sensors included in the data acquisition device. The data acquisition device has two open hose adapters which allow it to be installed in-line with and measure the flow rate of irrigation tubes. The top surface includes solar cells that provide power to the data acquisition device as well as a means of measuring solar radiation

The cloud-based data collection and analysis application is communicatively coupled to one or more data acquisition devices and collects and analyzes the sensor data. The data collection and analysis application uses the sensor data to produce one or more of the following analyses: irrigation system efficiency, irrigation system distribution uniformity, total field water usage estimation, water quality assessment, plant canopy growth tracking, irrigation system leakage detection, irrigation system blockage detection, irrigation system maintenance detection, extreme temperature detection, high wind detection, plant damage detection, and device theft detection. The data collection and analysis application may also incorporate one or more external data sources into one or more of its analyses in order to enhance the aforementioned analyses or to produce deficit irrigation schedules, or more generally, to schedules that irrigate to a certain percentage of localized plant water demand (ETc).

One or more of the data acquisition devices may be communicatively coupled to the cloud-based data collection and analysis application via one or more interne-connected gateway devices that the data acquisition devices are communicatively coupled to via a wireless network. The gateway devices may be placed in remote locations in a crop field and use energy harvesting and rechargeable power sources. The gateway device can transmit additional data to the cloud-based data collection and analysis application from one or more on-board sensors that measure one or more of the following: intensity of solar radiation, ambient temperature, ambient humidity and location (e.g., via a global positioning system (GPS)). This additional sensor data can be used by the data collection and analysis application to enhance one or more of the following analyses: plant canopy growth tracking, extreme temperature detection, high wind detection, plant damage detection, and device theft detection.

In some implementations, the data collection and analysis application can improve the accuracy of collected sensor data using calibration information for the specific sensors producing the sensor data.

In some implementations, the data collection and analysis application may send software packages to the data acquisition device and the gateway device, which can be installed by the data acquisition device and the gateway device in order to improve subsequent performance.

The user may review the raw and analyzed sensor data from one or more agricultural production environments under their management from the cloud-based user interface module. The user can also input data related to the condition of one or more agricultural production environments under their management in order to configure the display and processing of collected and analyzed data. The user interface module is accessible via an internet-connected client device, such as a personal computer (PC), laptop, or smartphone. The client device may access the user interface module via a website or a mobile device application. The user interface module can be operable to send alerts to one or more users based on analyzed data produced by the data collection and analysis application responsive to the analyzed data being determined to be of relevance to the one or more users. These alerts may include one or more of the following: smartphone/smartwatch notifications provided by the mobile device application, emails, phone calls, and text messages.

In some implementations, each data acquisition device and gateway device may include a unique identifier. The unique identifier may be electronically registered (e.g., with a data server that stores and manages a data structure describing one or more unique identifiers and each data acquisition device and gateway device associated with each unique identifier) so that the data acquisition devices and gateway devices associated with their unique identifiers may only be used with their associated cloud-based data collection and analysis application and user interface module. This approach beneficially enables security and discourages theft of the data acquisition devices and gateway devices.

### Example System

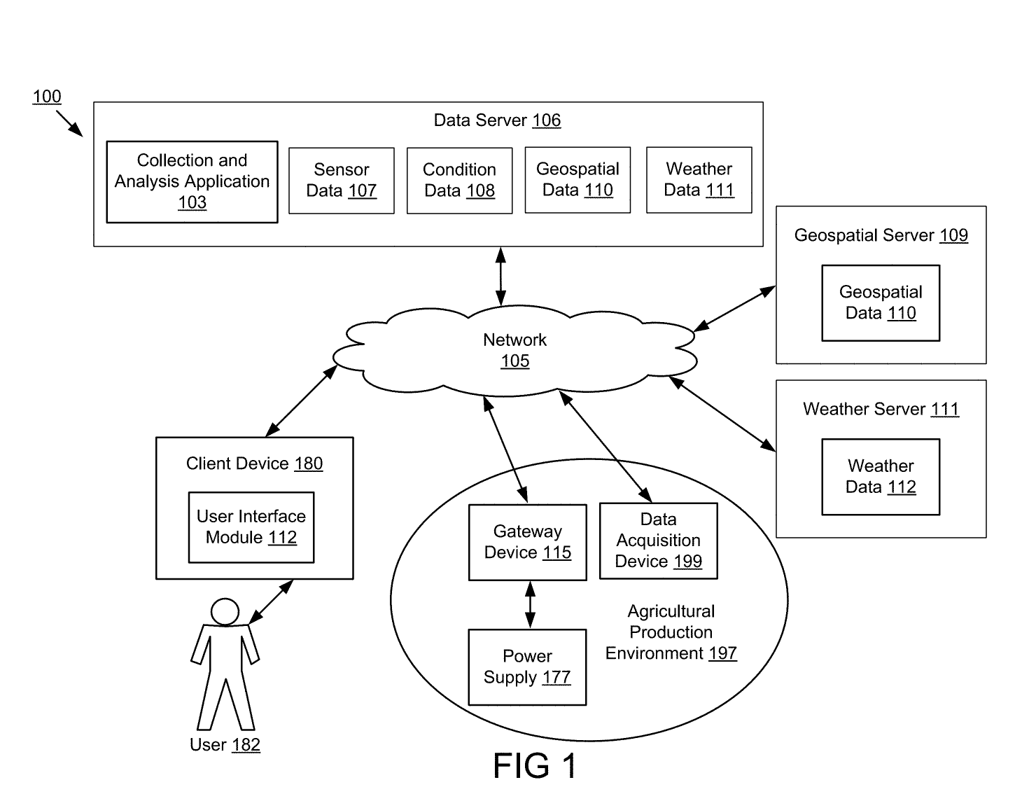

Referring now to FIG. 1, a block diagram of an agricultural production monitoring system 100 is illustrated. The agricultural production monitoring system 100 may include an agricultural production environment 197, a data server 106, and a client device 180 in accordance with at least one embodiment described herein. In some embodiments, the agricultural production monitoring system 100 may also include a geospatial server 109 and a weather server 111. These components of the agricultural production monitoring system 100 are communicatively coupled to one another via a network 105. Additions, modifications, or omissions may be made to the illustrated embodiment without departing from the scope of the disclosure, as will be appreciated in view of the disclosure.

The agricultural production environment 197 is the environment associated with the agricultural production monitoring system 100. For example, the agricultural production environment 197 may be a farm managed by user 182.

The agricultural production environment 197 may include one or more agricultural crop fields. These crop fields may be organized into rows of individual plants with uniform distances between individual plants and uniform distances between rows of plants. An irrigation system may be used to water the individual plants in these crop fields. The irrigation system components may consist of a collection pipes or tubes that originate from a common water pump and water source and which run down the length of each row of plants. The irrigation system components may include one or more of the following: sprinkler heads, drip irrigation hoses or drip emitters, and other micro-irrigation components used for distributing water to plants in a field. The irrigation system components may be arranged into one or more irrigation zones, or irrigation blocks, such that a single irrigation valve can be opened to a water pump to transfer water down a multiplicity of plant rows at one time.

The agricultural production environment 197 may include one or more gateway devices 115 and one or more data acquisition devices 199. The one or more gateway devices 115 may be coupled to one or more power supplies 177. The power supply 177 may include a 120-volt or 20-volt power supply or outlet. The power supply 177 may include a battery or a battery bank associated with one or more solar cells, a windmill, or any other power source. The one or more data acquisition devices 199 may include solar panels for capturing enough energy to function without a power supply.

The data acquisition device 199 may have two cylindrical openings that support being be installed in-line with an irrigation pipe or tube located along one or more rows of plants, such that the irrigation water flows through the component before it emitted to the plants. The data acquisition device 199 may be installed at a location beneath a plant's canopy, such that the solar energy transferred through the plant's canopy can be collected.

The top portion of the data acquisition device 199 may include solar cells that generate power sufficient to meet the needs of the data acquisition device 199. This power may be stored in one or more batteries, one or more capacitors, or a combination of one or more batteries and one or more capacitors of the data acquisition device 199.

The data acquisition device 199 includes one or more sensors for collecting or measuring sensor data 107. The data acquisition device 199 collects or measures the sensor data 107 and provides the sensor data 107 to the data server 106. In some embodiments, the data acquisition device 199 transmits the sensor data 107 to the gateway device 115, which includes hardware for transmitting the sensor data 107 to the data server 106 via the network 105. In other embodiments, both the data acquisition device 199 and the gateway device 115 capture sensor data 107. As a result, persons of ordinary skill in the art will recognize that references to sensor data 107 captured by the data acquisition device 199 may also refer to sensor data 107 captured by the gateway device 115. The sensor data 107 may describe the environment proximate to the sensor included in the data acquisition device 199.

The sensors included in the data acquisition device 199 are any device that sense physical changes. The data acquisition device 199 includes one or more sensors that measure one or more of the following: irrigation flow rate, irrigation water quality, intensity of solar radiation, ambient temperature, and ambient humidity. The data acquisition device 199 may collect sensor data 107. The sensor data 107 may describe the measurements of the one or more sensors included in the data acquisition device 199. The communication unit of the data acquisition device 199 may transmit the sensor data 107 to the gateway device 115, which transmits the sensor data 107 to the data server 106 via the network 105.

If more than one data acquisition device 199 is deployed, then the sensor data 107 may include an identifier of which data acquisition device 199 collected or measured the sensor data 107. In this way, the data server 106 may differentiate how the sensor data 107 applies to the different irrigation zones and the different conditions within the different irrigation zones.

The data server 106 includes a collection and analysis application 103 that may be operable to provide organized data as well as various data analyses based on one or more of the following: sensor data 107, condition data 108, geospatial data 110, and weather data 111. As described above, the data server 106 receives the sensor data 107 from the data acquisition device 199 and/or the gateway device 115. The data server 106 may receive the condition data 108 directly from the user 182. For example, the user 182 may provide inputs describing the condition data 108, for example, via a user interface generated by the user interface module 122. The user interface module 112 may be stored on the client device 180 and transmit the user inputs to the data server 106 via the network 105. The data server 106 may receive the geospatial data 110 from the geospatial server 109 via the network 105. The data server 106 may receive the weather data 111 from the weather server 111 via the network 105.

The condition data 108 may describe the different crop types associated with each data acquisition device 199. The condition data 108 may also describe the location of each data acquisition device 199, for example, by specifying GPS coordinates. The condition data 108 may also describe how many plants are located both upstream and downstream of where each data acquisition device 199 is installed in its row of plants.

The geospatial server 109 may include a processor-based computing device operable to provide a geospatial service. The geospatial service may provide geospatial conditions for different geographical locations. The geospatial data 110 may describe the geospatial conditions for the different geographic locations. The collection and analysis application 103 may use the geospatial data 110 alone or in combination with the weather 112 to produce deficit irrigation schedules, or more generally, to schedules that irrigate to a certain percentage of localized plant water demand (ETc).

The weather server 111 may include a processor-based computing device operable to provide a weather service. The weather service may provide weather conditions for different geographic locations. The weather data 111 may describe the weather conditions for the different geographic locations. In one embodiment, the collection and analysis application 103 uses the weather data 111 alone or in combination with the geospatial data 110 to produce deficit irrigation schedules.

The collection and analysis application 103 includes code and routines operable to analyze one or more of the sensor data 107, the condition data 108, the geospatial data 110, and the weather data 111 and to determine one or more of the following: irrigation system efficiency, irrigation system distribution uniformity, total field water usage estimation, water quality assessment, plant canopy growth tracking, irrigation system leakage detection, irrigation system blockage detection, irrigation system maintenance detection, extreme temperature detection, high wind detection, plant damage detection, and device theft detection.

The client device 180 may include a processor-based computing device used by the user 182 that is communicatively coupled with the user interface module 122. The client device 180 may include a smartphone, smartwatch, laptop, tablet computer, personal computer, smart hub operable to control one or more smart devices, a set-top box, etc. The client device 180 may include a mobile application.

The user 182 accesses information via the client device 180. The user 182 may be the same user that works with the agricultural production environment 197, for example, by installing one or more data acquisition devices 199 and/or one or more gateway devices 115. Alternatively or additionally, the user 182 may only work with the user interface module 122 to provide user inputs to the user interface module

The user interface module 122 may be an element of the client device 180. For example, the user interface module 122 may be a thin-client application operating on the client device 180 that is used to provide one or more user inputs to the collection and analysis application 103 stored on the data server 106. For example, the user interface module 122 may include code and routines that are operable to generate one or more graphical user interfaces displayed via a monitor or other display of the client device 180.

Although the user interface module 112 is illustrated as being stored on the client device, in some implementations, the user interface module 112 is part of the collection and analysis application 103 and it provides graphical data that is displayed on the client device 180. For example, the client device 180 may include a web browser that displays graphical information generated by the user interface module 112.

The network 105 may be a conventional type, wired or wireless, and may have numerous different configurations including a star configuration, token ring configuration or other configurations. Furthermore, the network 105 may include a local area network (LAN), a wide area network (WAN) (e.g., the Internet), or other interconnected data paths across which multiple devices may communicate. In some embodiments, the network 105 may be a peer-to-peer network. The network 105 may also be coupled to or include portions of a telecommunications network for sending data in a variety of different communication protocols. In some embodiments, the network 105 may include Bluetooth communication networks or a cellular communications network for sending and receiving data including via short messaging service (SMS), multimedia messaging service (MMS), hypertext transfer protocol (HTTP), direct data connection, WAP, email, etc.

Although FIG. 1 illustrates one network 105 coupled to some of the entities of the agricultural production monitoring system 100, in practice one or more networks 105 may be connected to these entities and the one or more networks 105 may be of various and differing types.

### Example Data Acquisition Device

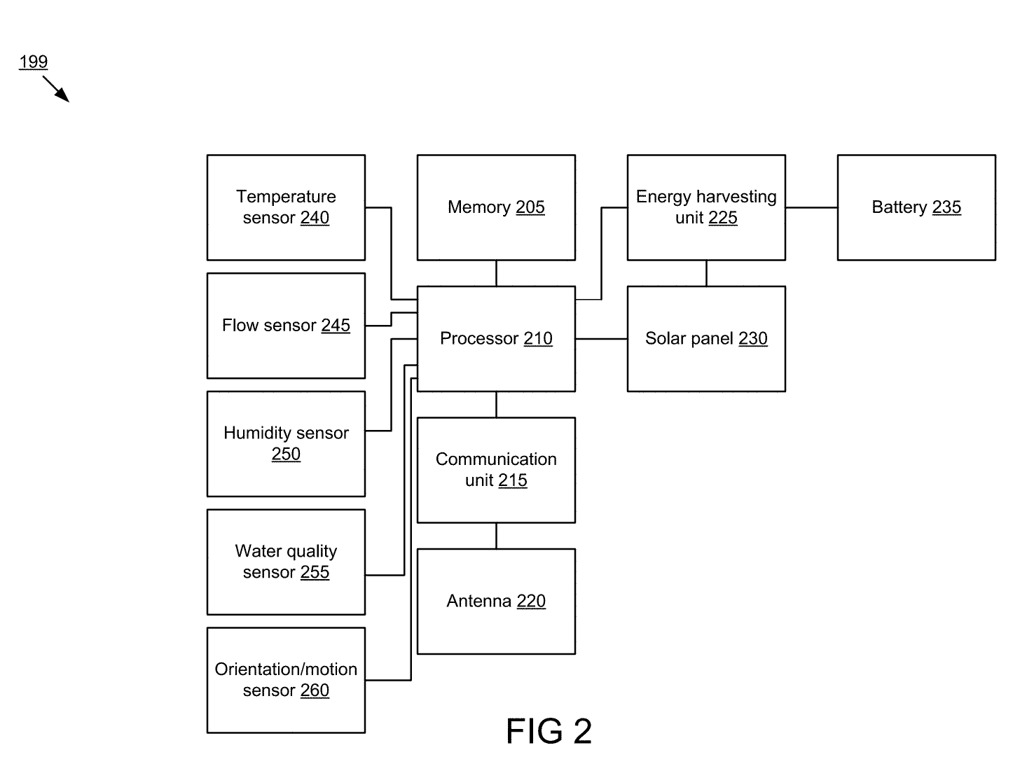

FIG. 2 illustrates a diagram of the data acquisition device 199 according to some embodiments. The data acquisition device 199 includes a memory 205, a processor 210, a communication unit 215, an antenna 220, an energy harvesting unit 225, a solar panel 230, a battery 235, a temperature sensor 240, a flow sensor 245, a humidity sensor 250, a water quality sensor 255, and an orientation/motion sensor 260. Persons of ordinary skill in the art will recognize that the data acquisition device 199 may include additional components or fewer components. For example, the data acquisition device 199 may include additional sensors.

The memory 205 is a non-transitory memory that is operable to provide storage and retrieval of data as needed during the functioning of the data acquisition device 199. The memory 205 includes any hardware and software needed for it to provide its functionality to the data acquisition device 199. The memory 205 may include one or more of the following: EEPROM memory, a memory card, and a solid-state drive. Example memory cards include, but are not limited to, a secure digital (SD) memory card, a secure digital high capacity (SDHC) memory card, a secure digital extra capacity (SDXC) memory card, and a compact flash (CF) memory card, etc. The memory 205 may store the sensor data 107. In some embodiments, the memory 205 may also store one or more of the condition data 108, the geospatial data 110, and the weather data 111.

The memory 205 is communicatively coupled to the processor 210. The processor 210 is operable to control the operation of the memory 205. For example, the memory 205 includes code and routines that are operable, when executed by the processor 210, to cause the processor 210 to control the operation of the memory 205.

The processor 210 is an electronic device that is operable to perform basic arithmetic, logical, control, and input/output (I/O) operations specified in the software program instructions of the data acquisition device 199. The processor 210 may include a microprocessor computer-processing unit (CPU). The processor 210 may process data signals and may include various computing architectures including a complex instruction set computer (CISC) architecture, a reduced instruction set computer (RISC) architecture, or an architecture implementing a combination of instruction sets.

The processor 210 may be communicatively coupled to the memory 205 to access and use one or more of the sensor data 107, the condition data 108, the geospatial data 110, and the weather data 111. The processor 210 may also be communicatively coupled to the sensors, power management, and wireless communications devices. The processor 210 is operable to control the operation of the sensors, power management, and wireless communications devices. For example, the memory 205 includes code and routines that are operable, when executed by the processor 210, to cause the processor 210 to control the operation of the sensors, power management, and wireless communications devices.

The communication unit 215 is an electronic device operable to facilitate wireless communications between the data acquisition device 199 and a network 105, such as a wireless communication network located within the agricultural production environment 197. The communication unit 215 includes any hardware and software needed to communicate with the data acquisition device 199. The communication unit 215 may be a wireless radio unit. For example, the communication unit 215 may include one or more of the following: LoRa, ZigBee, Software-Defined Radio, Wifi, cellular, and Bluetooth modules.

The communication unit 215 is communicatively coupled to the processor 210. The communication unit 215 transmits data including the sensor data 107 to the gateway device 115. The processor 210 is operable to control the operation of the communication unit 215. For example, the memory 205 includes code and routines that are operable, when executed by the processor 210, to cause the processor 210 to control the operation of the communication unit 215.

The antenna 220 is an electrical device that is operable to convert electric power into radio waves in order to transmit data wirelessly from the data acquisition device 199 to a remote receiver, and also to convert radio waves into electric power for the purpose of reception of data sent wirelessly from a remote transmitter to the data acquisition device 199. The antenna 220 may include one or more of the following: wire dipole, wire monopole, loop, Yagi-Uda array, microstrip patch, slot, and corner reflector antennas.

The energy harvesting unit 225 is an electronic device operable to harvest energy and store energy. The energy harvesting unit 225 includes hardware and software that are needed for it to harvest energy and store the energy. The energy harvesting unit 225 may include one or more of the following: solar, thermal, wind, salinity gradients, and kinetic energy harvesters. For example, the energy harvesting unit 225 may harvest energy from the solar panel 230 and transmit the energy to the battery 235 for storage.

The energy harvesting unit 225 is communicatively coupled to the processor 210. The processor 210 is operable to control the operation of the energy harvesting unit 225. For example, the memory 205 includes code and routines that are operable, when executed by the processor 210, to cause the processor 210 to control the operation of the energy harvesting unit 225.

The solar panel 230 is an electrical device that includes one or more photovoltaic cells that convert energy from light directly into electricity. The solar panel 230 provides a source of power for the data acquisition device 199. The solar panel 230 may include one or more of the following: crystalline silicon, amorphous silicon, and thin-film solar panels.

In some embodiments, the solar panel 230 includes a solar sensor, which is an electronic device that is operable to measure the solar energy incident upon the area proximate to the data acquisition device 199 and the nearby crops in the agricultural production environment 197. The solar sensor includes hardware and software that is needed to provide its functionality to the data acquisition device 199. The solar sensor may include one or more of the following: pyranometers, quantum sensors, net radiometers, irradiance sensors or combinations of solar panels with voltage and current sensors.

The solar sensor is communicatively coupled to the processor 210. The solar sensor may record voltage, current, and a time of day. The solar sensor may transmit solar data to the processor 210 to be incorporated into the sensor data 107 stored in the memory 205. The processor 210 is operable to control the operation of the solar sensor. For example, the memory 205 includes code and routines that are operable, when executed by the processor 210, to cause the processor 210 to control the operation of the solar sensor.

The battery 235 is an electrical device including one or more electrochemical or solid-state cells with external connections to provide power to the data acquisition device 199 and storage of energy made available by the energy harvesting unit 225. The battery 235 may include a rechargeable battery or a capacitor. The battery 235 includes hardware and software that are needed for it to receive and store energy. The battery 235 may include one or more of the following: lithium ion batteries, lithium iron phosphate batteries, super-capacitors, and electrolytic capacitors.

The battery 235 is electrically coupled to the processor 210. The processor 210 is operable to control the charging and discharging of the battery 235. For example, the memory 205 includes code and routines that are operable, when executed by the processor 210, to cause the processor 210 to control the charging and discharging of the battery 235.

The temperature sensor 240 an electronic device operable to measure temperatures. For example, the temperature sensor 240 may measure one or more of the following: the soil, the water within an irrigation tube of an irrigation system of the agricultural production environment 197, the ambient air temperature, and the soil proximate to an outlet of the irrigation system. The temperature sensor 240 includes any hardware and software that is used to provide temperature data to the data acquisition device 199. For example, the temperature sensor 240 includes one or more of the following: thermistors, resistive temperature detectors, thermocouples, and semiconductor temperature sensors.

The temperature sensor 240 may measure the temperature periodically, such as every minute, every hour, every day, etc. The temperature sensor 240 is communicatively coupled to the processor 210. The temperature sensor 240 transmits the temperature data to the processor 210 to be incorporated into the sensor data 107 stored in the memory 205. The processor 210 is operable to control the operation of the temperature sensor 240. For example, the memory 205 includes code and routines that are operable, when executed by the processor 210, to cause the processor 210 to control the operation of the temperature sensor 240.

The flow sensor 245 is an electronic device operable to measure the flow of fluids that travel through an irrigation tube of an irrigation system in the agricultural production environment 197. The flow sensor 245 includes any hardware and software that is needed for it to provide flow data to the data acquisition device 199. For example, the flow sensor 245 may include one or more of the following: turbine, paddlewheel, vortex, ultrasonic, positive displacement, and pressure flow sensors.

The flow sensor 245 may measure the flow data periodically, such as every minute, every hour, every day, etc. The flow sensor 245 is communicatively coupled to the processor 210. The flow sensor 245 transmits the flow data to the processor 210 to be incorporated into the sensor data 107 stored in the memory 205. The processor 210 is operable to control the operation of the flow sensor 245. For example, the memory 205 includes code and routines that are operable, when executed by the processor 210, to cause the processor 210 to control the operation of the flow sensor 245. The collection and analysis application 103 uses the sensor data 107 from the flow sensor 245 to determine an irrigation flow rate and/or an irrigation water quality.

The humidity sensor 250 is an electronic device operable to measure the relative concentration of water vapor in the air proximate to the crops grown in the agricultural production environment. The humidity sensor 250 includes any hardware and software that is needed for it to provide humidity data to the data acquisition device 199. For example, the humidity sensor 250 may include one or more of the following: capacitive, resistive, and thermal-based humidity sensors.

The humidity sensor 250 may measure the ambient humidity periodically, such as every minute, every hour, every day, etc. The humidity sensor 250 is communicatively coupled to the processor 210. The humidity sensor 250 transmits the humidity data to the processor 210 to be incorporated into the sensor data 107 stored in the memory 205. The processor 210 is operable to control the operation of the humidity sensor 250. For example, the memory 205 includes code and routines that are operable, when executed by the processor 210, to cause the processor 210 to control the operation of the humidity sensor 250.

The water quality sensor 255 is an electronic device operable to measure water attributes. For example, the water quality sensor 255 may measure and record one or more of the following attributes of the water within an irrigation tube of an irrigation system of the agricultural production environment 197: chemical, physical, biological, and radiological conditions. The water quality sensor 255 includes any hardware and software that is used to provide water attribute data to the data acquisition device 199. For example, the water quality sensor 255 includes one or more of the following: ph, electrical resistivity, electrical conductivity, turbidity, optical, oxidation reduction potential, and dissolved ion sensors.

The water quality sensor 255 may measure the water attribute data periodically, such as every minute, every hour, every day, etc. The water quality sensor 255 is communicatively coupled to the processor 210. The water quality sensor 255 transmits the water attribute data to the processor 210 to be incorporated into the sensor data 107 stored in the memory 205. The processor 210 is operable to control the operation of the water quality sensor 255. For example, the memory 205 includes code and routines that are operable, when executed by the processor 210, to cause the processor 210 to control the operation of the water quality sensor 255.

The orientation/motion sensor 260 is an electronic device operable to measure the physical orientation and motion of the data acquisition device 199. The orientation/motion sensor 260 includes any hardware and software that is used to provide orientation and motion data to the data acquisition device 199. For example, the orientation/motion sensor 260 includes one or more of the following: tilt sensors, magnetometers, accelerometers, and compasses.

The orientation/motion sensor 260 may measure the orientation and motion data periodically, such as every minute, every hour, every day, etc. The orientation/motion sensor 260 is communicatively coupled to the processor 210. The orientation/motion sensor 260 transmits the orientation and motion data to the processor 210 to be incorporated into the sensor data 107 stored in the memory 205. The processor 210 is operable to control the operation of the orientation/motion sensor 260. For example, the memory 205 includes code and routines that are operable, when executed by the processor 210, to cause the processor 210 to control the operation of the orientation/motion sensor 260.

### Example Gateway Device

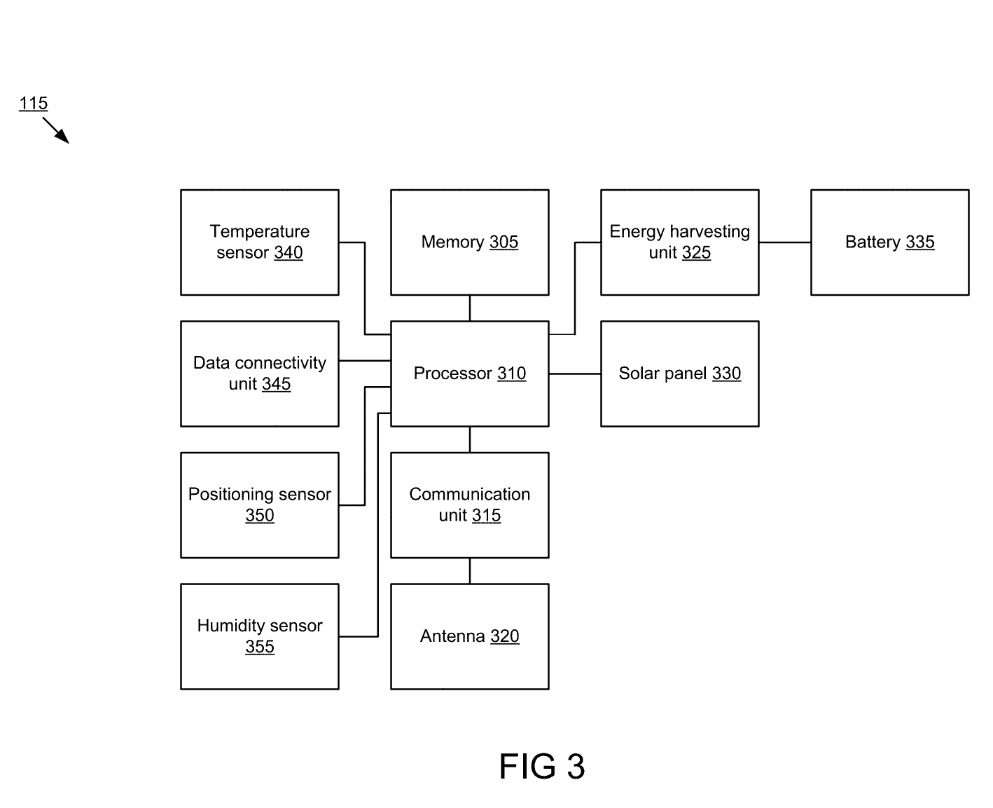

FIG. 3 illustrates a diagram of the gateway device 115 according to some embodiments. The gateway device 115 may include a memory 305, a processor 310, a communication unit 315, an antenna 320, an energy harvesting unit 325, a solar panel 330, a battery 335, a temperature sensor 340, a data connectivity unit 345, a positioning sensor 350, and a humidity sensor 355. The description of the memory 305, the processor 310, the antenna 320, the energy harvesting unit 325, the solar panel 330, the battery 335, the temperature sensor 340, and the humidity sensor 355 are similar to the components described above and will not be repeated here.

The communication unit 315 is an electronic device operable to transmit data to any of the entities that comprise the agricultural production monitoring system 100 depicted in FIG. 1. Similarly, the communication unit 315 may receive data from any of the entities that comprise the agricultural production monitoring system 100 depicted in FIG. 1. In some embodiments, the communication unit 315 includes a port for direct physical connection to a network, such as a network 105 of FIG. 1 or to another communication channel. For example, the communication unit 315 may include a port such as a USB, SD, RJ45 or similar port for wired communication with the client device 180. In some embodiments, the communication unit 315 includes a wireless transceiver for exchanging data with the client device 180 or other communication channels using one or more wireless communication methods, including IEEE 802.11, IEEE 802.16, BLUETOOTH®, near field communication, or another suitable wireless communication method.

In some embodiments, the communication unit 315 includes a cellular communications transceiver for sending and receiving data over a cellular communications network including via short messaging service (SMS), multimedia messaging service (MMS), hypertext transfer protocol (HTTP), Web Socket, MQTT, direct data connection, WAP, e-mail or another suitable type of electronic communication. In some embodiments, the communication unit includes a wired port and a wireless transceiver. The communication unit also provides other conventional connections to a network for distribution of data using standard network protocols including TCP/IP, HTTP, HTTPS and SMTP, etc.

The data connectivity unit 345 is an electronic device that is operable to transmit and receive data between the data acquisition device 199 and the remote data server 106. The data connectivity unit 345 includes any hardware and software that are needed to provide sensor data 107 and any other data to the data acquisition device 199. The data connectivity unit 345 may include one or more of the following: cellular modems, satellite modems, ultra narrowband, and wife modules.

The data connectivity unit 345 is communicatively coupled to the processor 310. The processor 310 is operable to control the operation of the data connectivity unit 345. For example, the memory 305 includes code and routines that are operable, when executed by the processor 310, to cause the processor 310 to control the operation of the data connectivity unit 345.

The positioning sensor 350 is an electronic device that is operable to measure the real-world geographic location of the data acquisition device 199 in the agricultural production environment. The positioning sensor 350 includes hardware and software that is needed for it to provide position data to the data acquisition device 199. For example, the positioning sensor 350 may include one or more of the following: GPS, GLONASS, and Wifi positioning sensors.

The positioning sensor 350 may record the position data periodically, such as every minute, every hour, every day, etc. The positioning sensor 350 is communicatively coupled to the processor 310. The positioning sensor 350 transmits the position data to the processor 310 to be incorporated into the sensor data 107 stored in the memory 305. The processor 310 is operable to control the operation of the positioning sensor 350. For example, the memory 305 includes code and routines that are operable, when executed by the processor 310, to cause the processor 310 to control the operation of the positioning sensor 350.

The gateway device 115 may download a patch or firmware update from the cloud for either the gateway device 115 or the data acquisition device 199 or both and apply the patch or update to either the gateway device 115 or the data acquisition device 199 or both.

### Example Flow Sensor

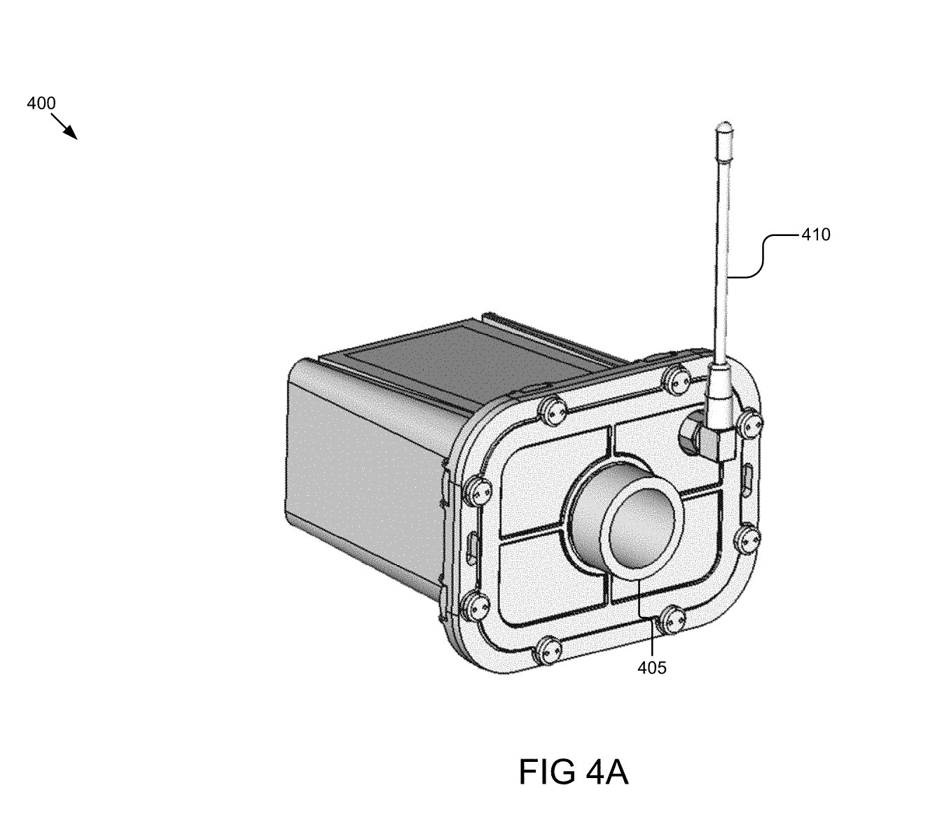

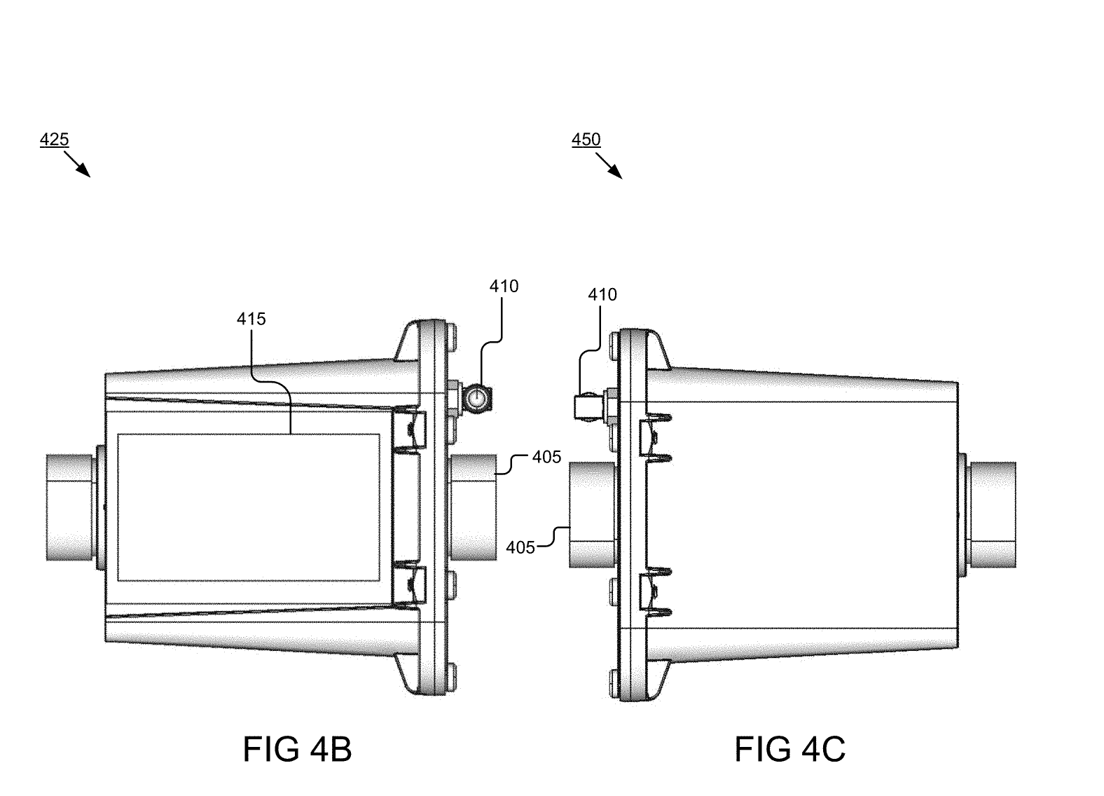

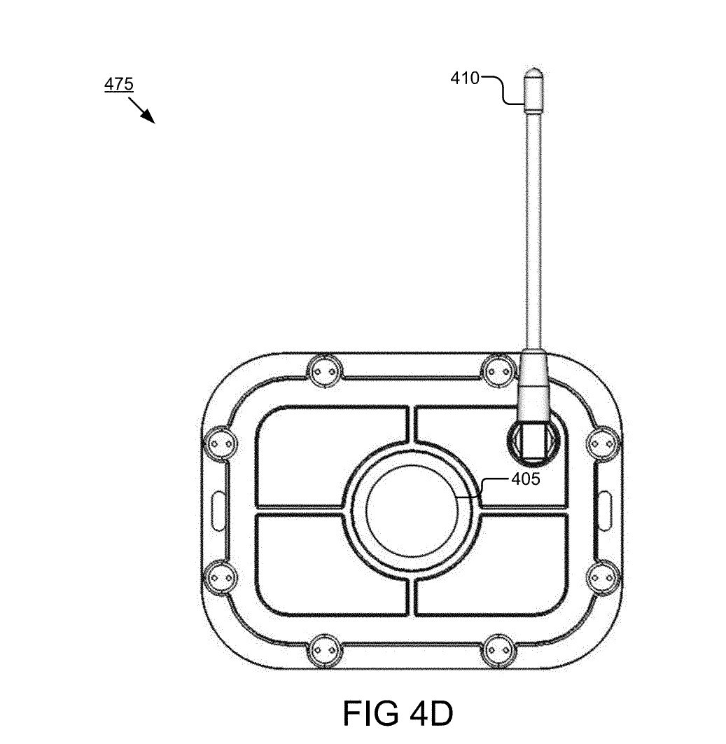

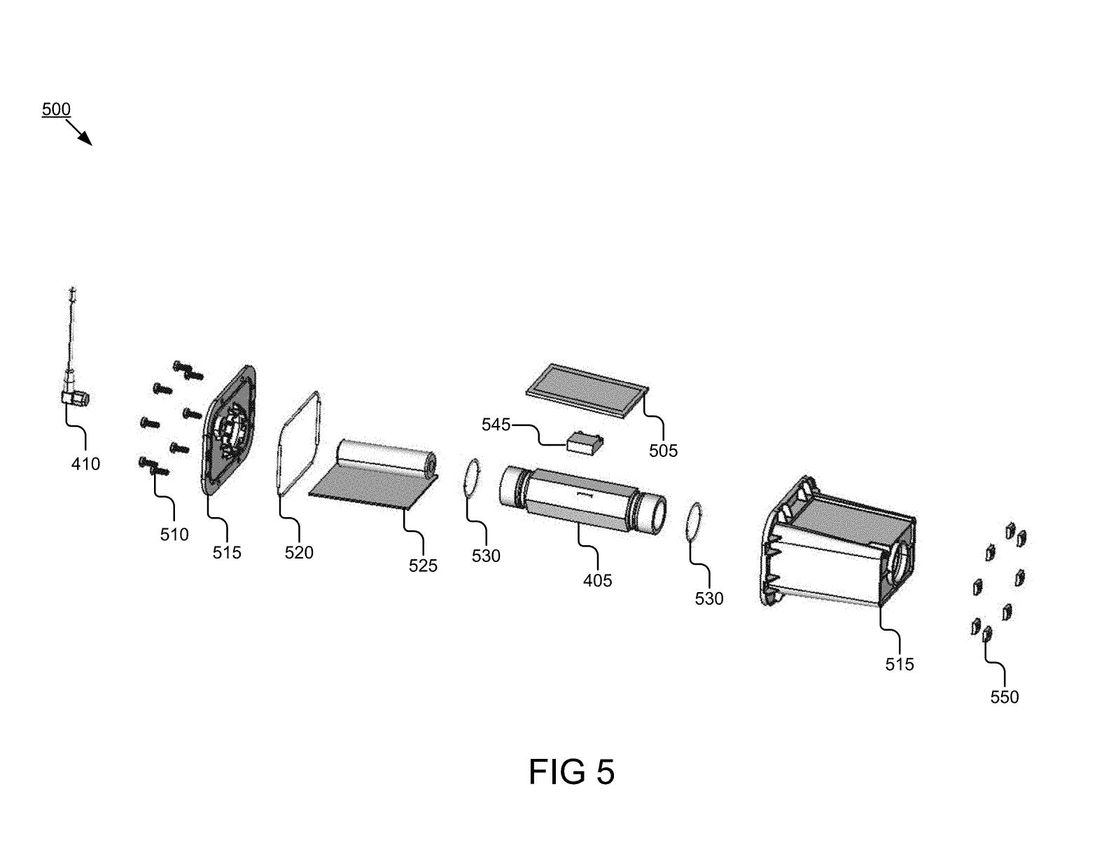

FIG. 4A illustrates an angled view 400 of a flow sensor 245 according to some embodiments. The flow sensor 245 is part of the data acquisition device 199. In some embodiments, the data acquisition device 199 and the gateway device 115 are installed in-line with an irrigation pipe or tube located along one or more rows of plants, such that the irrigation water flows through the flow sensor 245 before it emitted to the plants. In this way, the flow sensor 245 may accurately measure the water flow. FIG. 4A includes a flow meter part 405 that attaches to the irrigation pipe or tube. FIG. 4A also includes an antenna 410 for communicating with the gateway device 115.

FIG. 4B illustrates a plan view 425 of the flow sensor 245. The plan view 425 includes a photovoltaic solar panel 415, a top of the antenna 410, and the flow meter part 405.

FIG. 4C illustrates a bottom view 450 of the flow sensor 245. The bottom view 450 includes a bottom view of the antenna 410 and the flow meter part 405.

FIG. 4D illustrates a rear view 475 of the flow sensor 245. The rear view 475 includes the antenna 410 and the flow meter part 405.

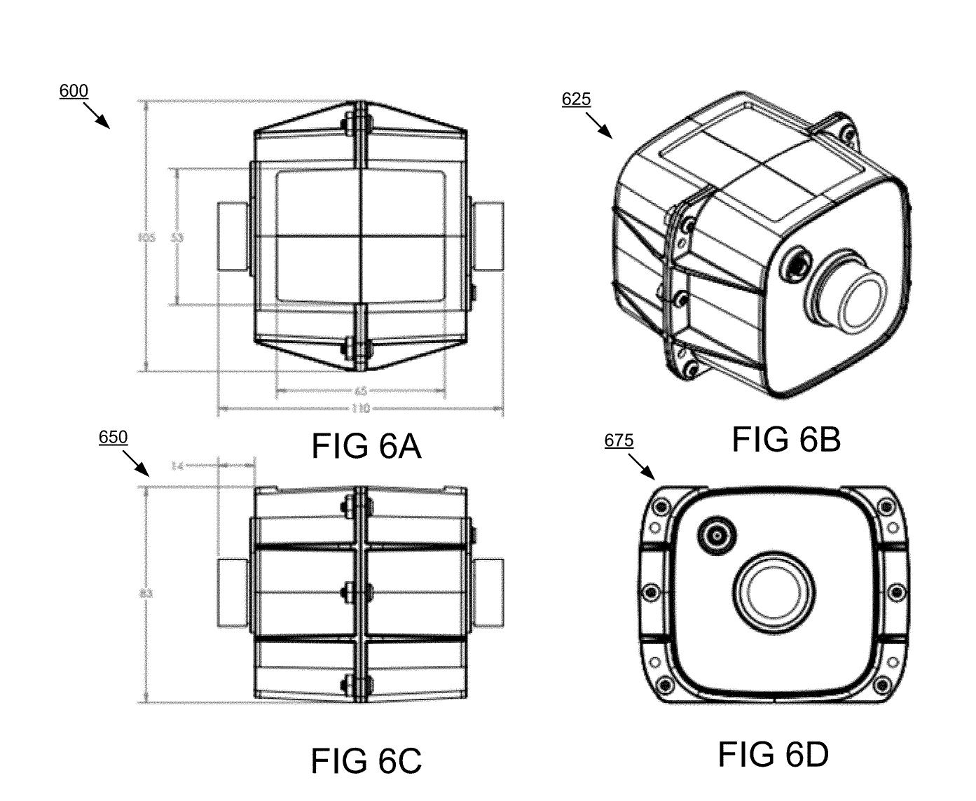

FIG. 5 illustrates an exploded view of the flow sensor according to some embodiments. The flow sensor 245 includes the antenna 410, screws 510, housing 515, face seal O-rings 520, a printed circuit board with an attached battery 525, flow meter O-rings 530, a flow meter part 405, a photovoltaic solar panel 505, a hall sensor 545, and nuts 550. The housing 515 may be made of a material that withstands environmental damage, such as plastic. The hall sensor 545 is operable to read movement of a flow meter impeller (now shown).

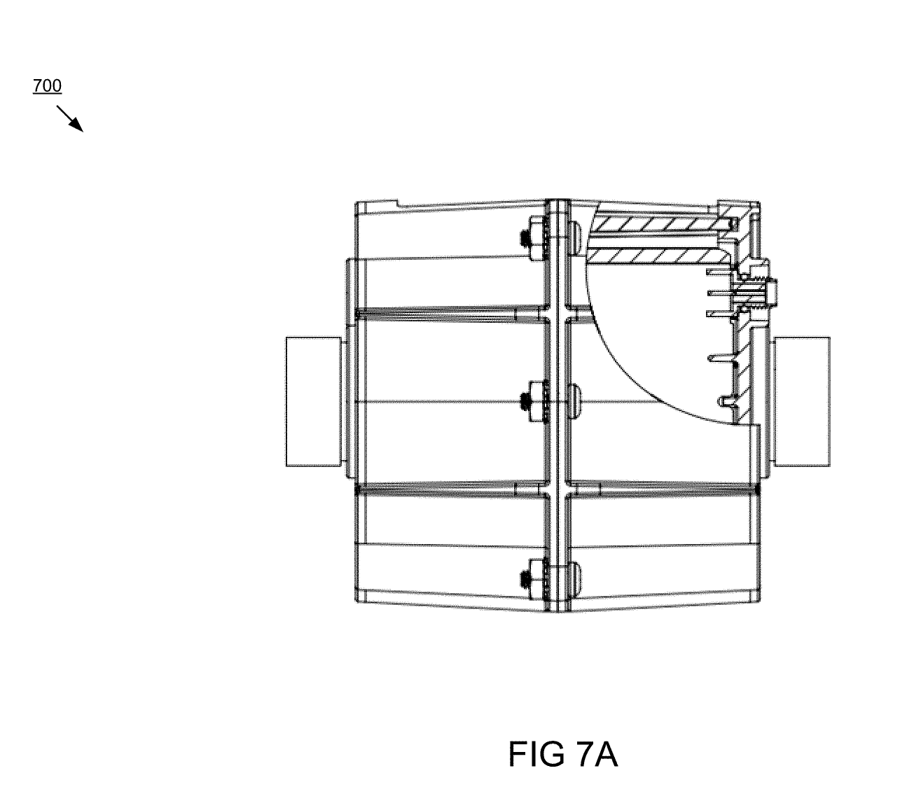

FIGS. 6A-6D illustrate four views of another embodiment of the flow sensor with orthographic dimensions. FIG. 6A illustrates a plan view 600 of the flow sensor 245. FIG. 6A also includes the different dimensions of the flow sensor 245. FIG. 6B illustrates an angled view 625 of the flow sensor 245. FIG. 6C illustrates a side view 650 of the flow sensor 245. FIG. 6C also includes the different dimensions of the flow sensor 245. FIG. 6D illustrates another side view 675 of the flow sensor 245 with a 90-degree rotation as compared to FIG. 6C.

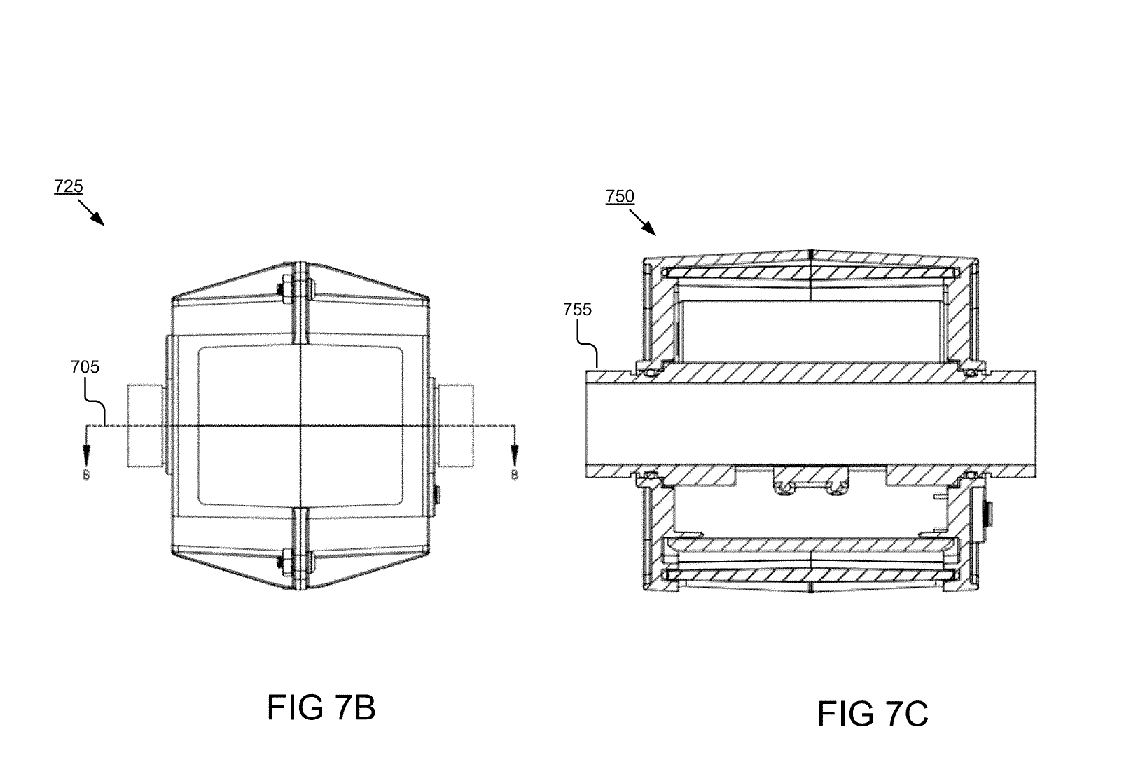

FIGS. 7A-7C illustrate section views of another embodiment of the flow sensor. FIG. 7A illustrates a broken-out section 700 of the flow sensor 245 according to some embodiments. FIG. 7B illustrates a plan view 725 of the flow sensor 245 according to some embodiments. FIG. 7C includes a cut line 705 to indicate the cut plane in FIG. 7A. FIG. 7C illustrates a section view 850 with the top of the flow sensor 245 cut off to illustrate a flow meter part 755 inside the flow sensor 245 according to some embodiments.

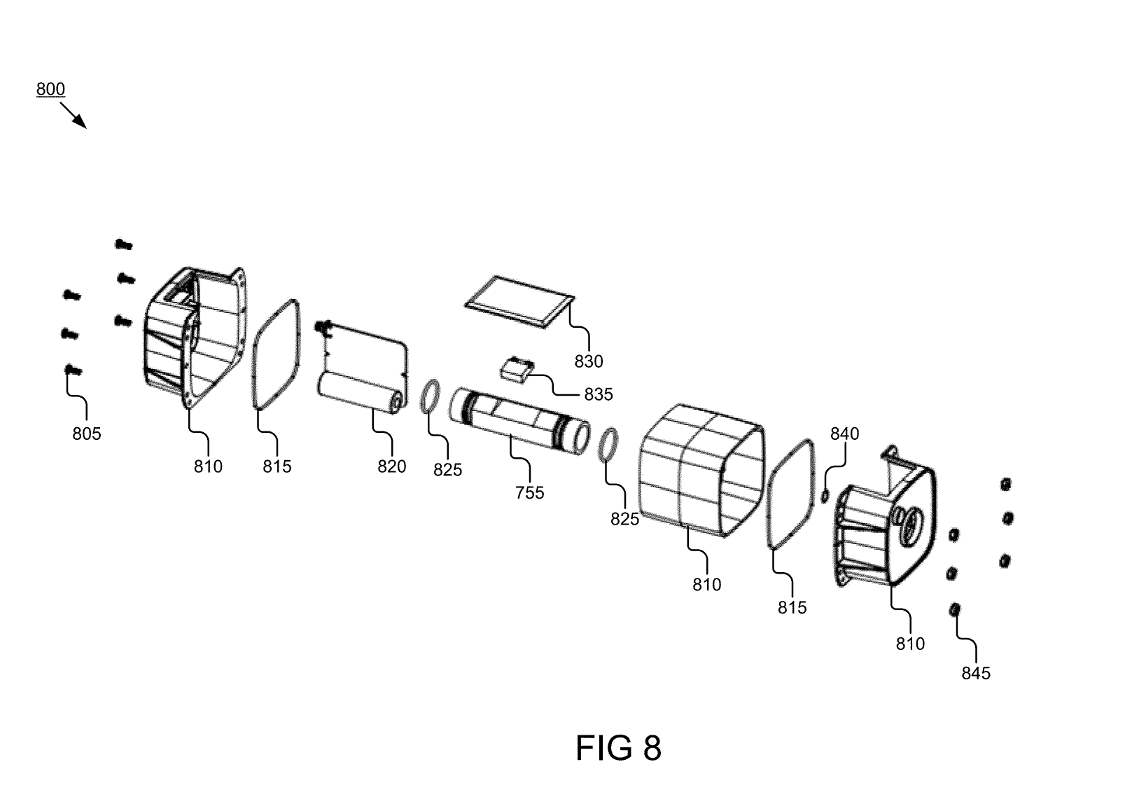

FIG. 8 illustrates an exploded view of another embodiment of the flow sensor according to some embodiments. The flow sensor 245 includes screws 805, housing 810, face seal 0-rings 815, a printed circuit board with an attached battery 820, flow meter O-rings 825, a flow meter part 755, a photovoltaic solar panel 830, a hall sensor 835, an antenna O-ring 840, and nuts 845. The housing 515 may be made of a material that withstands environmental damage, such as plastic. The hall sensor 545 is operable to read movement of a flow meter impeller (now shown).

### Example Collection and Analysis Application

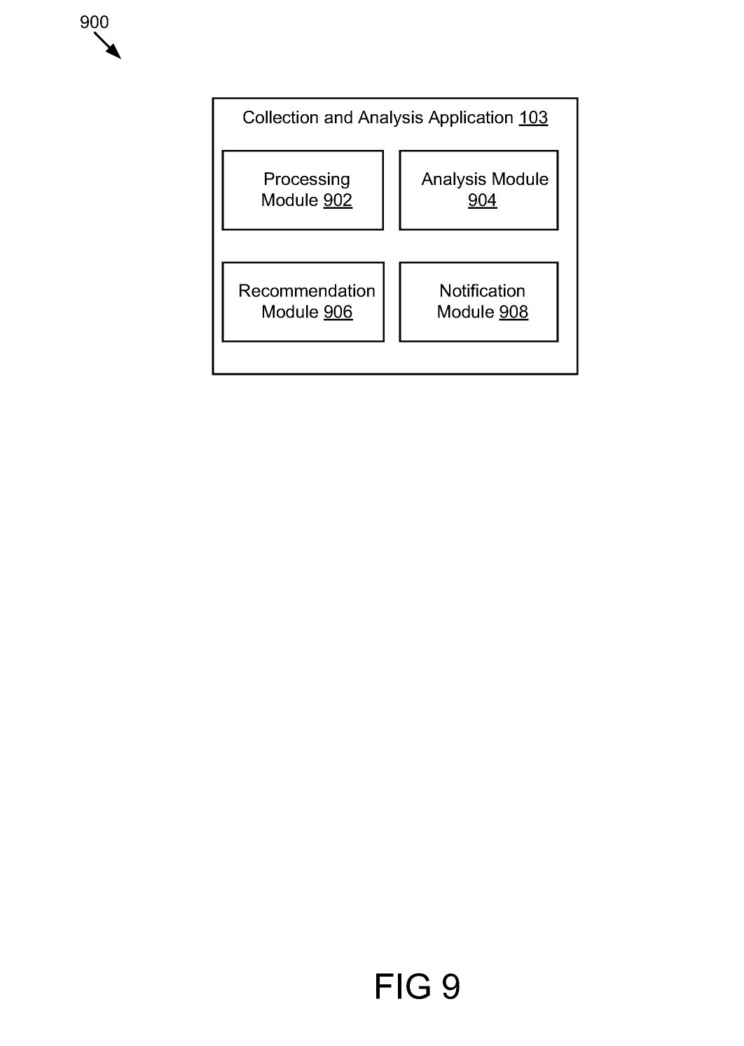

FIG. 9 illustrates a block diagram 900 of the collection and analysis application 103 according to some embodiments. In this embodiment, the collection and analysis application 103 is illustrated as including a processing module 902, an analysis module 904, a recommendation module 906, and a notification module 908. Other embodiments are possible, such as an embodiment where the user interface module 122 illustrated in FIG. 1 as being part of the client device 180 is instead part of the collection and analysis application 103.

The processing module 902 processes data. In some embodiments, the processing module 902 includes a set of instructions executable by a processor to process the data. In some embodiments, the processing module 902 is stored in a memory of the data server 106 and can be accessible and executable by the processor.

The processing module 902 receives sensor data 107 from the data acquisition device 199, condition data 108 from the client device 180, geospatial data 110 from the geospatial server 109, and weather data 111 from the weather server 111. The processing module 902 may organize the data based on types of data. For example, the processing module 902 may identify unique identifiers for each data acquisition device 199 and associate the unique identifiers with a time each data acquisition device 199 detected a flow, an amount of the flow, a temperature, a humidity, etc.

The analysis module 904 analyzes the data. In some embodiments, the analysis module 904 includes a set of instructions executable by a processor to analyze the data. In some embodiments, the analysis module 904 is stored in a memory of the data server 106 and can be accessible and executable by the processor.

The analysis module 904 analyzes the data and generates analyzed data. For example, the analysis module 904 may use the data processed by the processing module 902 to determine an amount of flow applied to each data acquisition device 199, a duration of the flow, a total flow applied during the duration, an average flow rate, and an estimated crop coefficient.

In some embodiments, the analysis module 904 adjusts the sensor data 107 for a sensor of the gateway device 115 or the data acquisition device 199 that requires calibration. For example, if the sensor data 107 for a sensor is incorrect by a repeatable pattern then the analysis module 904 adjusts the sensor data 107 by the amount observed in the repeatable pattern so that the sensor data 107 is accurate.

The recommendation module 906 generates recommendations based on the analyzed data. In some embodiments, the recommendation module 906 includes a set of instructions executable by a processor to generate recommendations. In some embodiments, the recommendation module 906 is stored in a memory of the data server 106 and can be accessible and executable by the processor.

The recommendation module 906 generates recommendations based on the analyzed data. For example, the recommendation module 906 may determine irrigation system efficiency and identify ways to make the irrigation system more efficient, such as areas where the flow is too high or too low. In another example, the recommendation module 906 may determine an irrigation system distribution uniformity and identify areas in the agricultural production environment 197 where the uniformity could be improved. In another example, the recommendation module 906 may track plant canopy growth and identify areas of undergrowth or overgrowth. In yet another example, the recommendation module 906 detects an irrigation system leakage or a blockage. The recommendation module 906 may identify a location of the leakage or blockage and recommend, for example, that a section of irrigation tubing be examined and/or replaced. In another example, the recommendation module 906 may perform irrigation system maintenance detection, identify areas in the agricultural production environment 197 that should be examined for further service, and recommend that a user examine the area. In another example, the recommendation module 906 may perform extreme temperature detection and identify a location where further service may be needed, such as activating frost protection systems. In yet another example, the recommendation module 906 may perform high wind detection and identify a location where further service may be needed, such as a location where the plants should be protected from the high winds. In another example, the recommendation module 906 detects plant damage and identifies the location of the plant so that a user can check on the plant and/or replace the plant. In yet another example, the recommendation module 906 detects theft of a data acquisition device 199 and identifies a location of the stolen data acquisition device 199. In another example, the recommendation module 906 detects water quality issues and identifies the location of the detected issues so the user can investigate the water source.

The notification module 908 generates notifications. In some embodiments, the notification module 908 includes a set of instructions executable by a processor to generate the notifications. In some embodiments, the notification module 908 is stored in a memory of the data server 106 and can be accessible and executable by the processor.

In some embodiments, the notification module 908 sends a notification to the client device 180 responsive to a triggering event occurring. The triggering event may be responsive to the recommendation module 906 generating a recommendation. In some embodiments, the triggering event may be configured by the user 182. For example, the user may specify a preference to receive a notification responsive to the recommendation module 906 determining that a flow rate falls below a predetermined threshold, a data acquisition device 199 is identified as having been stolen, the temperature falls below a threshold temperature, etc.

The notification module 908 sends the notification to the client device 180. The notification module 908 may send the alert to the client device 180 as an email to an email application associated with the user 182, a text to the client device 180 where the client device is a mobile device, a call with an automated message, a notification customized for a smartwatch, etc. In some embodiments, the user interface module 112 generates a user interface that includes a notification section that includes all notifications sent to the notification module 908.

### Example User Interfaces

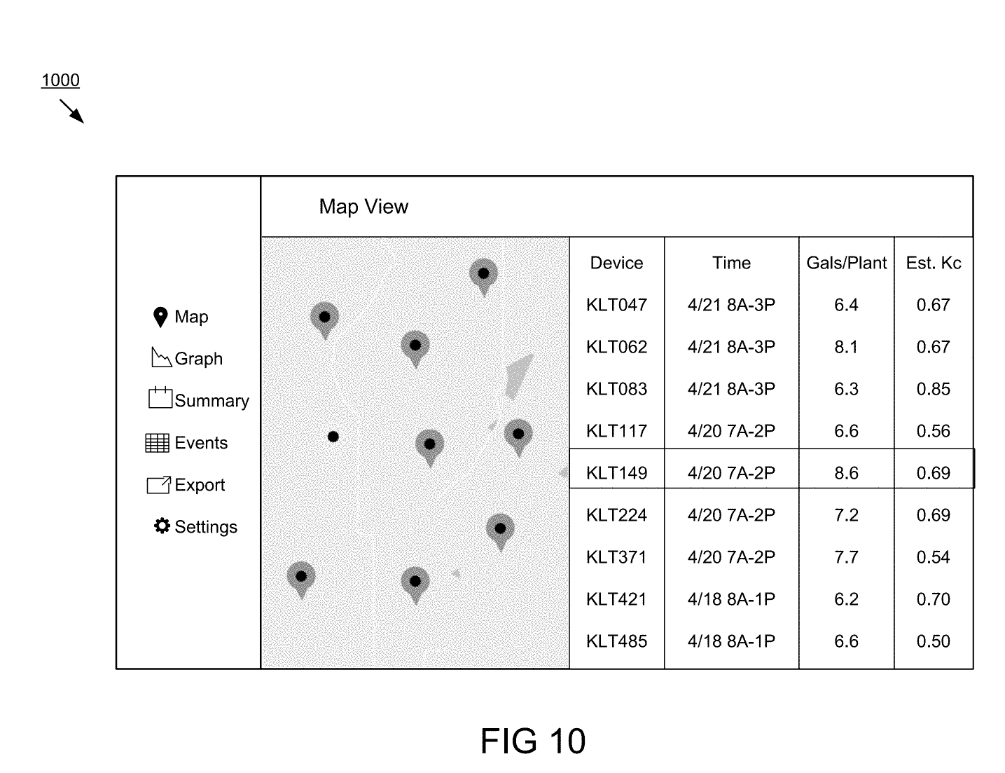

FIG. 10 illustrates an example graphical user interface 1000 of a map view generated by the collection and analysis application 103 according to some embodiments. The map view includes a map of the location of each data acquisition device 199, a device identifier for each data acquisition device 199, a time that each data acquisition device 199 detected irrigation flow, a flow rate associated with each data acquisition device 199, and an estimated crop coefficient associated with each data acquisition device 199.

In some embodiments, the collection and analysis application 103 receives the sensor data 107 from the data acquisition devices 199 and uses the sensor data 107 to identify device identifiers for each of the data acquisition devices 199. The collection and analysis application 103 identifies the amount of water that flows over a given time period from the sensor data 107. The collection and analysis application 103 determines the total amount of water applied as gallons per plant and the average flow rate as gallons per plant. The collection and analysis application 103 estimates the crop coefficient (Ku) as, for example, a ratio of evapotranspiration for the particular crop divided by the a well calibrated reference crop.

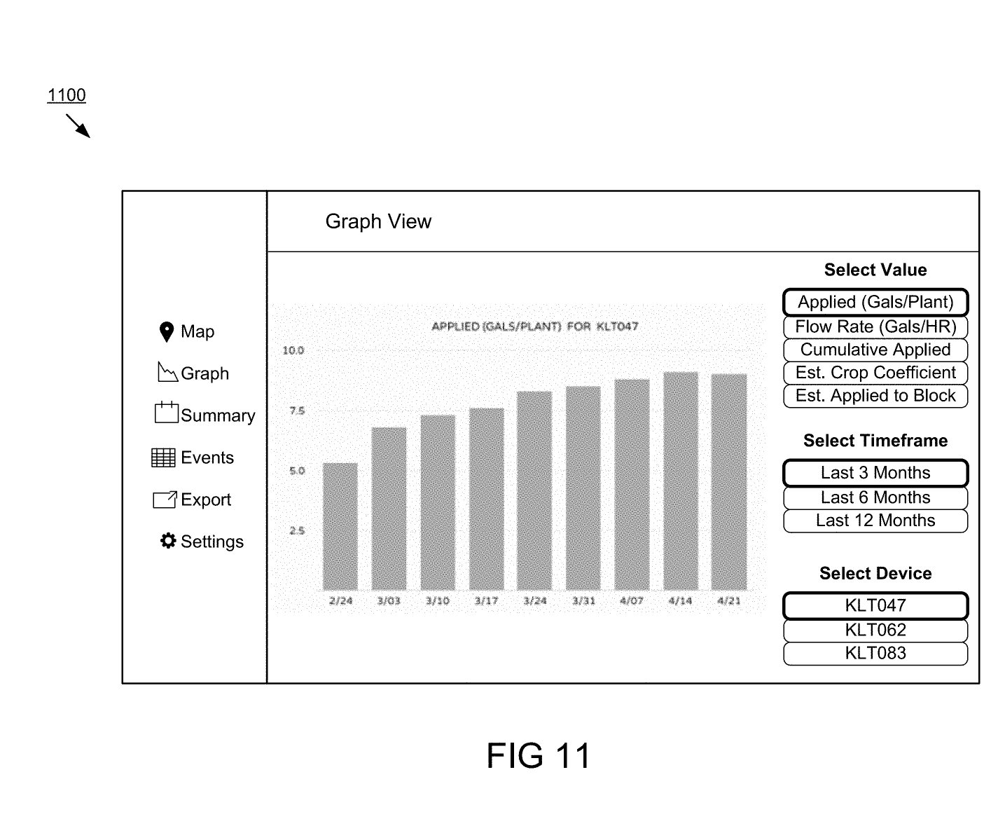

FIG. 11 illustrates an example graphical user interface 1100 of a graph view generated by the user interface module 112 according to some embodiments. The graph view includes a graph of the number of gallons of water applied per plant as a function of the date. The graph view includes options for viewing different values, such as flow applied (gallons per plant), a flow rate (gallons per hour), cumulative flow applied, an estimated crop coefficient, and an estimated amount of flow applied to a block. The graph view also includes options for viewing different timeframes, such as values for the past three months, six months, and year. Lastly, the graph view includes options for viewing different devices. In FIG. 11, a graph of the applied flow is displayed for the data acquisition device 199 identified as KLT047. Alternatively, the graph view could include values for KLT062 or KLT083.

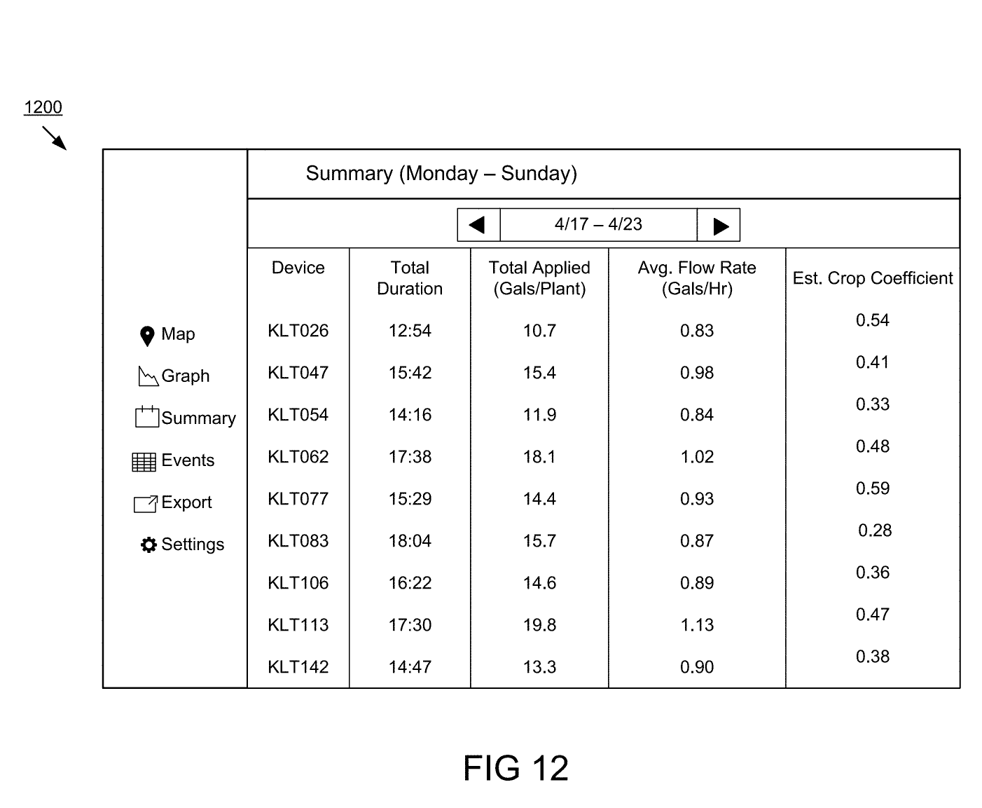

FIG. 12 illustrates an example graphical user interface 1200 of a summary view generated by the interface module 112 according to some embodiments. The summary view includes a summary of flow data for the past week. Specifically, the summary identifies different data acquisition devices 199, a total duration of flow detected by each data acquisition device 199, a total flow applied in gallons per plant, an average flow rate in gallons per hour, and an estimated crop coefficient.

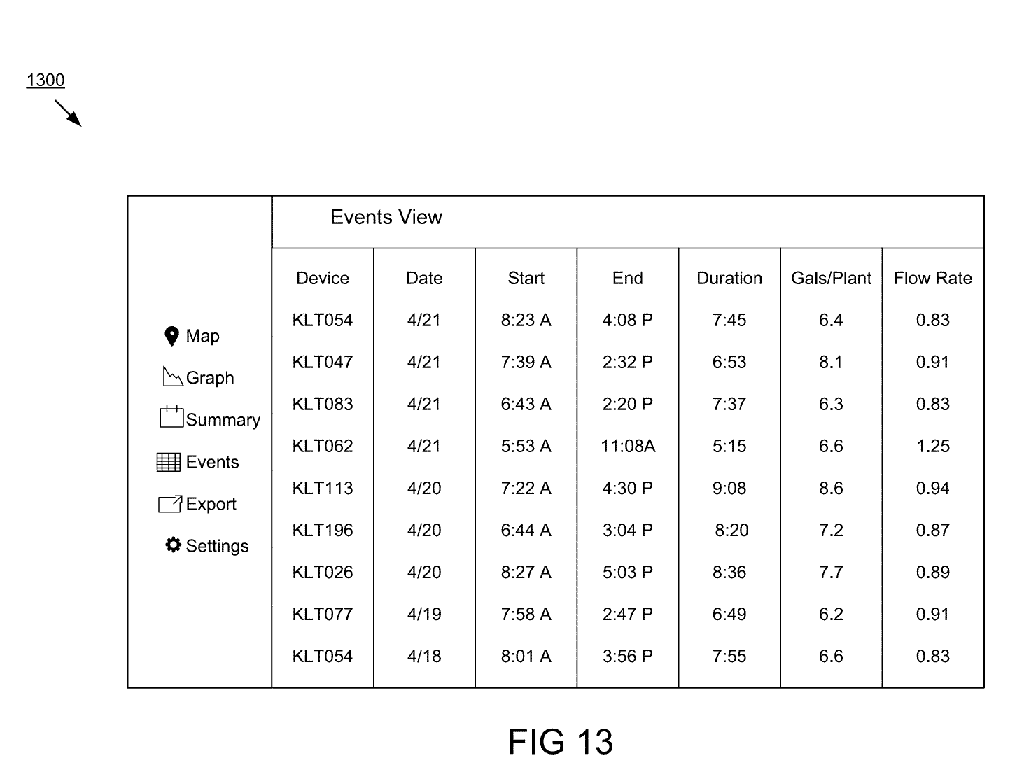

FIG. 13 illustrates an example graphical user interface 1300 of an event view for data acquisition devices 199 in an agricultural production environment generated by the interface module 112 according to some embodiments. The event view illustrates information about an event for each particular device. In this example, the event is defined as the data acquisition device 199 detecting a flow. The events view includes an identification of the device, a date the event occurred, a start of the event, an end of the event, a duration of the event, a total flow applied in gallons per plant, and an average flow rate in gallons per hour.

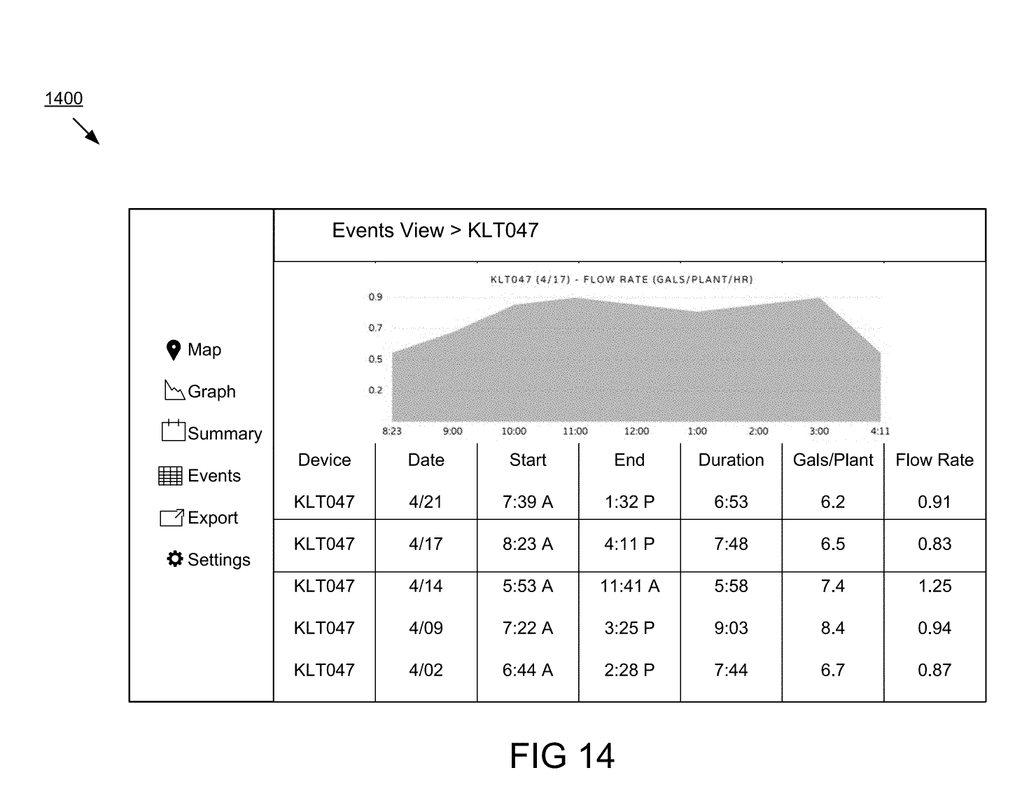

FIG. 14 illustrates a graphical user interface 1400 of an event view for events corresponding to a data acquisition device 199 generated by the interface module 112 according to some embodiments. The graph includes the flow rate as a function of the time of day for the second event listed for the data acquisition device 199 identified as KLT047. The summary below the graph identifies different data acquisition devices 199, a total duration of flow detected by each data acquisition device 199, a total flow applied in gallons per plant, an average flow rate in gallons per hour, and an estimated crop coefficient.

### Example Method

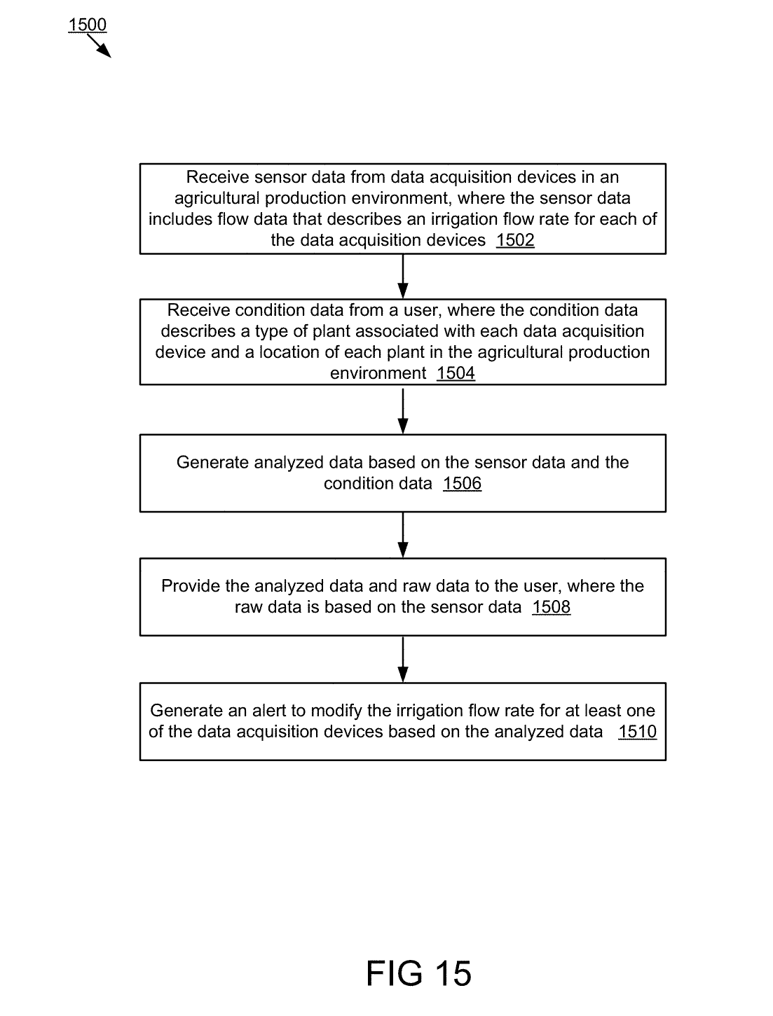

FIG. 15 illustrates an example flow diagram of a method 1500 for generating analyzed data about an agricultural production environment.

At block 1502, sensor data 107 is received from data acquisition devices 199 in an agricultural production environment 197, where the sensor data 107 includes flow data that describes an irrigation flow rate for each of the data acquisition devices 199. The sensor data 107 may also measure irrigation water quality, an intensity of solar radiation, ambient temperature, and ambient humidity.

At block 1504, condition data 108 is received from a user 182, where the condition data 108 describes a type of crop associated with each data acquisition device 199 and a location of each crop in the agricultural production environment 197. The user 182 may provide the condition data 108 by inputting the condition data 108 into a user interface module 112 that is stored on a client device 180 or that is part of a collection and analysis application 103 stored on a data server 106.

At block 1506, analyzed data is generated based on the sensor data 107 and the condition data 108. For example, the collection and analysis application 103 generates analyzed data that includes a flow applied to a plant, a duration of the flow, an average flow rate, a total flow applied to the plant, and a crop coefficient.

At block 1508, the analyzed data and raw data is provided to the user 182, where the raw data is based on the sensor data 107. For example, the collection and analysis application 103 may organize the analyzed data and the raw data into categories, such as a map view, a graph view, a summary view, and an event view. The collection and analysis application 103 may instruct the user interface module 112 to generate graphical data to display the analyzed data and the raw data. For example, the collection and analysis application 103 may be stored on the data server 106 and transmit the instructions to a user interface module 112 stored on the client device 180.

At block 1510, an alert may be generated to modify the irrigation flow rate for at least one of the data acquisition devices 199 based on the analyzed data. For example, the collection and analysis application 103 may determine that a plant associated with a particular data acquisition device 199 is receiving insufficient water based on the flow rate and other analyzed data. The collection and analysis application 103 may alert the user 182 to modify the irrigation flow rate for the plant. The collection and analysis application 103 may send the alert to the client device 180 as an email to an email application associated with the user 182, a text to the client device 180 where the client device is a mobile device, a call with an automated message, a notification customized for a smartwatch, etc.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include tangible computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions comprise, for example, instructions and data which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware embodiments operable to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware embodiments or a combination of software and specific hardware embodiments are also possible and contemplated. In this description, a “computing entity” may be any computing system as previously defined herein, or any module or combination of modules running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the inventions have been described in detail, it may be understood that the various changes, substitutions, and alterations could be made hereto without departing from the spirit and scope of the invention.

What is claimed is:

1. An agricultural production monitoring system, comprising:
a data acquisition device comprising one or more sensors, wherein the data acquisition device is operable to collect sensor data from the one or more sensors that measure one or more of the following: irrigation flow rate, irrigation water quality, intensity of solar radiation, ambient temperature, and ambient humidity;
a user interface module operable to collect condition data from a user; and
a collection and analysis application communicatively coupled to the data acquisition device, the collection and analysis application operable to receive the sensor data from the data acquisition device, receive the condition data from the user interface module, analyze the sensor data and the condition data, and generate analyzed data from the sensor data and the condition data; and
wherein the user interface module is further operable to generate a user interface that includes the analyzed data from the collection and analysis application.

2. The system of claim 1, wherein the data acquisition device is communicatively coupled to the data collection and analysis module component via a cellular communication transceiver.

3. The system of claim 1, further comprising a gateway device that sends the sensor data from the data acquisition device to the data collection and analysis device via a wireless network.

4. The system of claim 3, wherein the gateway device connects to an internet via using one or more of the following: wifi, ethernet, and cellular connections.

5. The system of claim 3, wherein the gateway device is powered by a renewable power source operable to harvest energy and charge a gateway power supply using the harvested energy.

6. The system of claim 3, wherein the gateway device transmits sensor data to the data collection and analysis application from one or more on-board sensors that measure one or more of the following: intensity of solar radiation, ambient temperature, ambient humidity and location.

7. The system of claim 6, wherein the data collection and analysis application uses the sensor data from both the data acquisition device and the gateway device to perform one or more of the following analyses: plant canopy growth tracking, extreme temperature detection, high wind detection, plant damage detection, and device theft detection.

8. The system of claim 1, wherein the data acquisition device is powered by a renewable power source operable to harvest energy and charge its power supply using the harvested energy.

9. The system of claim 1, wherein the data collection and analysis component performs one or more of the following analyses: irrigation system efficiency, irrigation system distribution uniformity, total field water usage estimation, water quality assessment, plant canopy growth tracking, irrigation system leakage detection, irrigation system blockage detection, irrigation system maintenance detection, extreme temperature detection, high wind detection, plant damage detection, and device theft detection.

10. The system of claim 1, wherein the data collection and analysis application generates a regulated deficit irrigation schedule based on the sensor data, condition data, geospatial data, and weather data.

11. The system of claim 1, wherein the data collection and analysis application generates an irrigation schedule that irrigates to a set percentage of localized plant water demand (ETc) based on the sensor data, condition data, geospatial data, and weather data.

12. The system of claim 1, further comprising a client device that includes the user interface module, wherein the client device displays a user interface generated by the user interface module.

13. The system of claim 1, wherein the collection and analysis application is further operable to issue alerts to the user based on the analyzed data.

14. A method for agricultural production monitoring, comprising:
receiving sensor data from data acquisition devices in an agricultural production environment, wherein the sensor data includes flow data that describes an irrigation flow rate for each of the data acquisition devices;
receiving condition data from a user, wherein the condition data describes a type of plant associated with each data acquisition device and a location of each plant in the agricultural production environment;
generating analyzed data based on the sensor data and the condition data; and
providing the analyzed data to the user.

15. The method of claim 14, wherein the sensor data is further based on sensors that measure one or more of the following: irrigation flow rate, irrigation water quality, intensity of solar radiation, ambient temperature, and ambient humidity.

16. The method of claim 14, further comprising providing raw data to the user, wherein the raw data is based on the sensor data.

17. The method of claim 14, wherein the analyzed data includes one or more of the following: irrigation system efficiency, irrigation system distribution uniformity, total field water usage estimation, water quality assessment, plant canopy growth tracking, irrigation system maintenance detection, irrigation system leakage detection, irrigation system blockage detection, extreme temperature detection, high wind detection, plant damage detection, and device theft detection.

18. The method of claim 14, further comprising generating an irrigation schedule that irrigates to a set percentage of localized plant water demand (ETc) using a combination of the sensor data from the data acquisition device, condition data from the user, geospatial data, and weather data.

19. The method of claim 14, further comprising generating regulated deficit irrigation schedules using a combination of sensor data from the data acquisition device, condition data from the user, geospatial data, and weather data.

20. The method of claim 14, further comprising sending an alert to the user based on the analyzed data.

21. The method of claim 14, wherein the data collection and analysis application uses additional intensity of solar radiation, ambient temperature, and ambient humidity data from a gateway device to perform one or more of the following analyses: plant canopy growth tracking, extreme temperature detection, high wind detection, plant damage detection, and device theft detection.

22. The method of claim 14, wherein providing the analyzed data to the user includes generation of a user interface that includes one or more of the following: a map view, a graph view, a summary view, and an event view.
